(19) United States
(12) Patent Application Publication
(10) Pub. No.: US 2007/0248730 A1
(43) Pub. Date: Oct. 25, 2007

(54) Method and system for treating a distilled spirit

(76) Inventors: Rick Wood, Cedar Rapids, IA (US); Johannes van Leeumen, Ames, IA (US); Jacek A. Koziel, Ames, IA (US)

Correspondence Address: JOHANNES VAN LEEUWEN, 203 HICKORY DRIVE, AMES, IA, 50014, US

(21) Appl. No.: 11/408,041

(22) Filed: Apr. 21, 2006

(51) Int. Cl. A23P 1/00; C12C 11/00; C12G 3/12

(52) U.S. Cl. 426/494; 426/11

(57) ABSTRACT

A method and system for treating a distilled spirit wherein the spirit is contacted with ozone to provide an ozonated distilled spirit product of improved aroma, taste or character.

### BACKGROUND OF THE INVENTION

The invention relates to treating a distilled spirit to produce a high quality product and to a system to carry out the treatment. More particularly, the invention relates to a method and system for treating whiskey to improve taste, aroma or character.

Certain fermentation components impart an undesirable aftertaste or bitter flavor to a distilled spirit that may be imbibed as an alcoholic beverage. These components can impart a burning sensation, making a whiskey “harsh” and leaving the mouth “leathery” to add to nausea and “overhang” after excessive consumption. Some of these components cause malodors. The difference between a high quality whiskey and a cheaper mass product is often based on absence or presence of these unwanted components, also known as congeners. Additionally, consumer taste preference in distilled spirits is shifting away from heavy-bodied spirits to spirits having a lighter body.

Producing a lighter bodied whiskey of improved quality and controlling or removing undesirable odor and taste components can be important to maintain or improve quality of a distilled alcoholic beverage and hence its demand. Aging of whiskeys in oak barrels removes or masks some of disagreeable taste, aroma and character depreciating components and enhances the whiskey quality. However, aging is expensive both in equipment and footprint. Removal of some undesirable substances by aging can require up to 10 years.

There is a need to improve the quality of a distilled spirit, particularly whiskey by effectively removing undesirable taste, aroma and character constituents within a reasonable length of time. There is a need for purification and quality enhancement of whiskey.

### BRIEF DESCRIPTION OF THE INVENTION

The invention relates to taste, aroma or character improvement of a distilled spirit and particularly to purification and quality enhancement of whiskey by ozonation.

In a first embodiment, the invention is a method of treating a distilled spirit, comprising contacting the distilled spirit with ozone and recovering an ozonated distilled spirit product of improved aroma, taste or character.

In another embodiment, the invention is a method of processing a whiskey, comprising continuously charging a condensed distilled fermentation product to the top of a processing column to flow downwardly through the column; supplying ozone to the bottom of the processing column to flow countercurrently against and to intimately contact the downwardly flowing product to produce an ozonated product from the whiskey; charging the ozonated product from the processing column to the top of an adsorption column; and flowing the ozonated product downwardly through the adsorption column to recover an improved whiskey product at the bottom of the adsorption column.

In another embodiment, the invention is a system for processing a whiskey, comprising: an ozone generator; and a contact tower with a lower continuous ozone contacting gas feed from the ozone generator, an upper liquid whiskey feed and a recovery port to recover an ozonated whiskey product.

### BRIEF DESCRIPTION OF THE DRAWINGS

FIG. 1 is a schematic representation of system to produce an upgraded distilled spirit;

FIG. 2 is a chromatogram for each of whiskeys;

FIG. 3 is a headspace chromatogram;

FIG. 4 is a bar graph comparison of spirit samples;

FIG. 5 is an ion chromatogram;

FIG. 6 is a bar graph comparison of detector response;

FIG. 7 is a bar graph comparison of headspace data;

FIG. 8 is a bar graph comparison of headspace odor; and

FIG. 9 is a bar graph comparison of headspace odor intensity.

### DETAILED DESCRIPTION OF THE INVENTION

In this application, a distilled spirit is a stimulating ethyl alcohol beverage prepared for consumption by distillation from a substance such as wine, grain or wood and containing 15 percent or higher ethanol. The particular taste, aroma and character of a distilled spirit can be due to substances other than alcohol that are produced during fermentation and maturation. These substances are known in the art as congeners. Congeners are generally higher alcohols, organic acids, esters, aldehydes, tannins and the like that are contained in various amounts in distilled spirits. The amounts of congeners in a relatively heavy-bodied distilled spirit such as a whiskey, is much greater than a lighter bodied distilled spirit such as a grain neutral spirit and vodka that are treated to be without substantial character, aroma or taste other than that of ethanol itself.

Typically, distilling and aging processes are manipulated by distillers and bottlers to obtain a proper mix and level of congeners to produce a desired aroma, taste and character. Taste is a distinctive perception and sensation of a distilled spirit in the mouth. Aroma is a spirit quality that can be perceived by the olfactory sense. Character is an inherent complex of attributes and characteristic properties that uniquely distinguish one spirit from another. Other definitions, properties, and methods of production of distilled spirits are discussed in Grossman's Guide to Wines, Beers and Spirits (Wiley Publishing Inc., 7th ed. 1983), the disclosure of which is incorporated herein by reference in its entirety.

The invention provides a method to adjust the quality of a distilled spirit. The method improves flavor and bouquet by removing odor emitting and taste depreciating substances within a short treatment time rather than by several years aging. While this invention encompasses the modification of the flavor of gin, brandy, fruit brandies, grain neutral spirits and vodka and ethanol, in a preferred embodiment the invention improves the taste, aroma or character of whiskey. Whiskey is a spirit distilled from the fermented mash of cereal grains, usually barley, wheat, rye or maize. Whiskey is distilled at less than 190° proof, 95% alcohol by volume, in a manner that the distillate possesses the taste, aroma and character generally attributed to whiskey. The term “whiskey” herein, can be defined as in Title 27, Code of Federal Regulations. Title 27 provides that whiskey is an alcohol distillate from a fermented mash. The production of whiskey generally involves the mashing of milled grain (i.e. gelatinization and saccharification of the starch therein), fermentation of the mash, distillation of the fermented mash and aging maturation of the distillate in charred wooden casks or barrels. In this specification, the term “whiskey” also includes light whiskey, rye whiskey, bourbon whiskey, wheat whiskey, malt whiskey, rye malt whiskey, straight single malt whiskey and blended whiskey.

To produce whiskey, a grain fermentation product is subjected to distillation, by which most of the ethanol is vaporized and condensed in a separate vessel. Along with the ethanol, other low boiling organic compounds and some water are vaporized and condensed. These volatiles add specific distinctive flavors to the distillate, depending on the raw materials used in the original brew. Modern commercial whiskey production is done by blending mass produced fermentation-derived ethanol, e.g. from corn, so-called neutral grain spirits with certain specific flavor and color enhancing substances.

Grossman (Grossman's Guide, supra) describes several whiskey making processes including the process of Scotch whiskey making. Scotch whiskey is obtained primarily from barley. There are five main stages in making Scotch: malting, mashing, fermenting, distilling and maturing and blending.

In the process first, the barley is “dressed,” that is, sieved, or passed over screens so that small and inferior grain is eliminated. The grain is then stored until required for use. Then, it is placed in tanks called steeps, where it is soaked in water until thoroughly softened. The barley is subjected to drum maltings and then turned regularly to control temperature and rate of germination or sprouting. This is done by hand using wooden shovels known as shields.

The starch in the grain in an original form is not fermentable. During a germination process, a chemical change occurs in the grain. The enzyme amylase, also called diastase in the beverage industry, is produced. The diastase converts starch into sugars, maltose and dextrin, which are fermentable.

The germinated or sprouted grain is called green malt. The green malt is transferred to a kiln, where it rests on a screen directly above a peat fire. Like green wood, peat gives off a much more acid and oilier smoke than soft coal. The smoke swirls around the grain, which becomes impregnated with the smoke aroma. Drying is then completed over burning coke or anthracite. The length of time that the peat is burned determines the smokiness of the malt and, eventually, of the whiskey.

Next, the malt is subjected to kilning or drying. During this step, malt acquires a substantial part of its character. The kilned malt is then screened to remove the culm or dried sprouts, after which it is passed to a mill room, where it is ground into a meal or grist. The meal is thoroughly mixed with warm water in a mash tun, also referred to as a mash tub. The meal soaks until the water has liquefied all of the malt starches and the diastase has converted the starches into sugar. The water with absorbed grain “goodness” is then is drawn off and cooled.

The cooled liquid is known as wort. The wort is passed into fermenting vats, where a small quantity of cultivated pure yeast is added. Fermentation then takes place. The yeast acts upon the sugars in the wort to produce alcohol and carbon dioxide gas.

Most of the aroma and odor in whiskey and in any original beverage alcohol originates in the fermentation process. The fermentation process generally is conducted under anaerobic conditions that prevent oxidation of these substances. Then, all volatile substances are evaporated during the distillation and condensed with the alcohol. The distillate ends up containing reduced aroma, taste and character.

The invention relates to the purification of a commercially produced distilled spirit using ozonation. Ozone (O₃) is an allotropic form of oxygen. It is an unstable blue gas with a pungent odor, a molecular weight of 48 g/mol and a density as a gas of 2.154 g/liter at 0° and 1 atm. It is approximately 13 times more soluble in water than is oxygen. Ozone is highly unstable and is a powerful oxidizing agent. It is non-persistent and has a very short half-life.

Typically, ozone is produced by passing oxygen, in some concentration, through a highly charged corona field; a technique known as “corona discharge”. The corona may be produced by applying a very high electric potential (up to 20 kV) between two conductors that are separated by an insulating dielectric layer and a small air gap. Under these conditions, molecular oxygen (O₂) passing through the gap between the conductors experiences sufficient dissociation energy to partially dissociate. A certain fraction of the free oxygen radicals will associate with oxygen molecules to form O₃, according to the reaction equation:
3O₂+69 kcal [symbol] 2O₃ (I)

The generation of ozone as represented by equation (I), is an equilibrium reaction. The reaction is endothermic to produce O₃, requiring energy, and is exothermic to produce O₂, giving up energy. Because of its equilibrium nature, actual conversion to ozone is relatively low, in the range of 2-14%, depending on the oxygen content of feed gas, the temperature of the reaction and properties of the ozone generator

In an embodiment, the invention removes unpleasant aroma and taste by treating with ozone and adsorption on granular activated carbon (GAC). In an embodiment, the invention relates to a process for treating a distilled alcohol with ozone and adsorption, preferably with granular activated carbon to remove impurities in minutes instead of years to produce a high quality alcoholic beverage. Ozonation has “generally regarded as safe” (GRAS) status and may be used in food processing. GRAS status is established by the Food and Drug Administration (See Federal Register Citation 66 FR 33829, docket number 00F-1482, Jun. 26, 2001, Final rule: Electric Power Research Institute, Agriculture and Food Technology Alliance, Ozone in gaseous and aqueous phase as an antimicrobial agent on food, including meat and poultry, 21 CFR 173.368).

Features of the invention will become apparent from the drawings and following detailed discussion, which by way of example without limitation describe preferred embodiments of the invention.

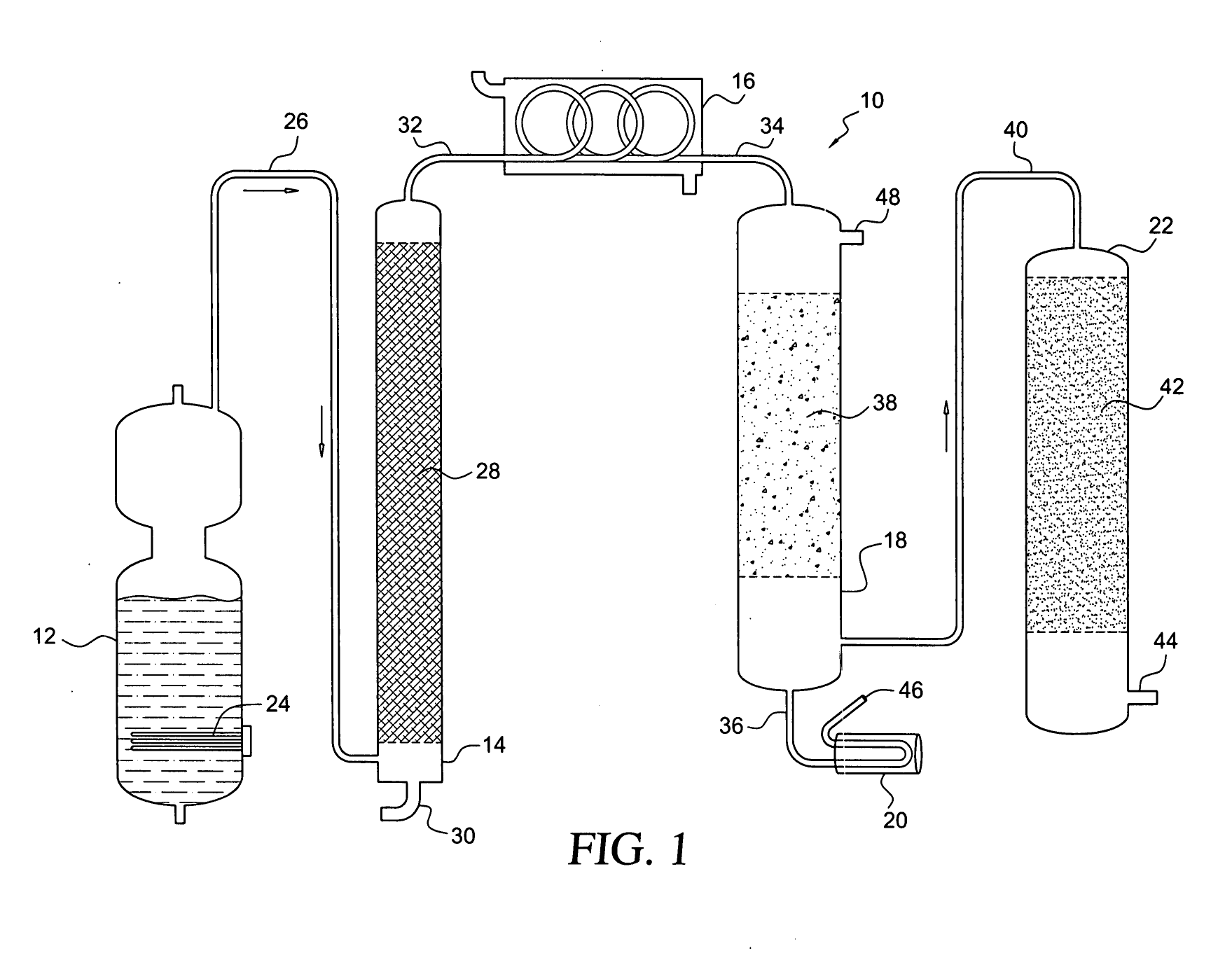

FIG. 1 schematically shows a system 10 to produce an upgraded distilled spirit from a grain mash. The system 10 includes cooker 12 to distill a fermented grain mash, distillation column 14, cooler 16, gas/liquid contact tower 18, ozone generator 20, and filtration column 22. In one process of the invention, ingredients are mixed to form a mash of grain, for example of course ground corn; sugar, yeast and water. The mash ferments at an elevated temperature, for example between 90 to 95° F. for a period of five to seven days. In this period, yeast converts sugar to alcohol. The mash can be strained and heated by coils 24 in cooker 12 to boiling at a temperature between 192 to 196° F. Cooking produces a vapor substantially of water and ethanol that passes through overhead conduit 26 that leads to distillation column 14. The distillation column 14 includes packing 28 to collect entrained liquid from the vapor. Collected liquid exits the column 14 at a bottom conduit 30.

The temperature at the top of the column 14 can be maintained between about 172 to 176° F. so that water vapor condenses and eventually passes down to and exits via the bottom conduit 30. An ethanol rich steam passes from the top of the column 14 via conduit 32 to a cooler 16, where it is condensed into an ethanol-rich liquid. The liquid is fed 34 to the top of gas/liquid contact tower 18. The contact tower 18 can contain a contact medium to promote contact between liquid and gas.

Ozone generator 20 is shown connected by ozone feed line 36 to a lower part of the contact tower 18. The ozone generator 20 can be a typical electric discharge based generator that applies a charge to an air feed 46 to convert a portion of the feed to ozone rich discharge gas. For example, the generator 20 can be a corona discharge ozone generator that uses either a desiccated air feed or a pure oxygen feed. The ozone air/oxygen mixture can be reacted with the liquid in a batch arrangement or in continuous flow as illustrated in FIG. 1. Ducting for the ozonated gas into the liquid contact vessel can be of an ozone resistant material to avoid deterioration of both the material and the liquor. Examples of such materials are glass, stainless steel of suitable grade (304 or 316), Teflon®, Viton® and ceramic materials.

In a batch arrangement, a quantity of liquid is placed in a container or vat and an ozone gas mixture is dispersed through the liquid using porous diffusers at the end of a gas line. Porous diffusers can be submerged in liquid to a depth for example of at least 6 inches and up to 20 feet. The gas mixture is introduced gradually over a period of at least 10 minutes for lower ozone dosages and longer for higher dosages.

Continuous ozonation as shown in FIG. 1 can be effected by pumping the liquid into the contact tower 18 at a rate matching a rate of ozone/gas mixture inflow. The rates are adjusted to provide a target level of ozone introduction and contact with the liquid. An arrangement of porous diffusers in the contact tower 18 can be similar to that described for batch equipment.

In the FIG. 1 embodiment, ozone rich gas from generator 20 is fed via line 36 to the contact tower 18 to rise upward through the tower 18 countercurrent to downward flowing ethanol rich liquid. The countercurrent flow and the contact medium 38 within the tower effect an intimate contact between the ethanol rich liquid and gas to effectively ozonate the liquid. After ozone has dissolved into the liquor, the remaining air or oxygen is discharged at 48.

In an alternative contact method, the liquid is pumped in a line through a venturi or eductor or injector. The eductor or injector serves to suck ozone gas into the liquid line to mix the gas with the liquid. The resulting liquor/gas mixture can continue to flow within the line with or without a static mixer that can serve to ensure gas/liquid contact. Then, the mixture is conveyed within the line into a contact vessel. Retention time in the vessel should be at least 1 minute to provide an opportunity for the inert gases (air or oxygen) to escape.

Ozone dosage is a function of impurities to be removed. Dosages of ozone between 5 mg/L to 1000 mg/L (ozone to liquid) can be effective. However in some applications, a dosage of more than 30 mg/L is undesirable as producing a medicinal taste. The dosage can be linked and determined by GC/MS headspace analyses of volatiles. The analysis can identify unwanted compounds to control ozone dosage.

In the FIG, 1 method, ozone treated liquid passes from tower 18 via line 40 to the top of filtration column 22. In this example, the filtration column 22 is filled with GAC 42. The ozone treated liquid percolates through the column 22 to remove ozone precipitated congeners. The treated liquid emerges 44 from the column 22 as an upgraded alcohol product such as an upgraded distilled spirit or an upgraded alcohol beverage. In a preferred embodiment, the system produces a whiskey which is upgraded in aroma, taste and character.

The following EXAMPLEs are illustrative and should not be construed as a limitation on the scope of the claims unless a limitation is specifically recited. The EXAMPLEs represent work conducted in concert with the Institute for Physical Research Technology and Iowa State University. In the EXAMPLEs, the Black Velvet whiskey was an 80 proof (40% alcohol) blended whiskey and aged in oak barrels, from Barton Brands, Canada; the Jack Daniels was an 80 proof (40% alcohol) distilled from a corn, rye and malted barley sour mash, aged in white oak and distilled from copper stills and filtered through hard sugar-maple charcoal, from Brown-Forman Corp., Lynchburg, Tenn., US; the E & J Brandy was an 80 proof (40% alcohol) distillate from fermented fruit and grapes with butterscotch and vanilla notes and aged in barrels from E & J Gallo Winery, CA, US; the Everclear was a 190 proof (95% alcohol) corn fermented distillate from David Sherman, St. Louis, Mo., US; the Paramount Rum was an 80 proof (40% alcohol) sugar cane fermented distillate from Robert Gottesman and Associates, the Virgin Islands and bottled in Cleveland, Ohio, US; and the Seagram Gin was an 80 proof (40% alcohol) distilled from a barley ferment, aged in charred oak barrels with cardamom, cassia bark, orange peel, coriander seed and angelica root and compounded and distilled by Pernod Richard, Lawrenceburg, Ind., US.

### EXAMPLE 1

A system including a gas/liquid vessel, ozone generator and adsorption vessel was built on lab scale and was used to ozonate and to subject samples to adsorption. In the procedure, ozone was generated from a commercial ozone generator (OZX-300U, Enaly Corporation, Shanghai) of 200 to 300 mg/h capacity and with an internal air pump. Ozone was measured using the iodometric method as published in Standard Methods for Examination of Water and Wastewater by the American Public Health Association, American Water Works Association and the Water Environment Federation, 20^{th} Edition, 1999.

Ozone dosages ranging from 5 to 100 mg/L were applied. No ozone emerged from the liquor as it was all consumed in reactions in the liquor. The ozonated liquors were transferred to a vessel containing granular activated carbon (Filtrasorb® 300, Calgon Corporation, Pittsburgh) and retained there for 2-10 minutes. The liquor was then filtered through a 100 μm screen.

Three liquors, Black Velvet whiskey, Jack Daniels whiskey and a vodka were ozonated for exploratory studies and analysis using gas chromatography and mass spectrometry for the quantification and identification of the flavor compounds. TABLE 1 presents the samples that were prepared and analyzed. TABLE 1 shows initial ozonation and granular activated carbon contacting test samples.

TABLE I

| | Alcohol | |
|---|---|---|
| Run | Beverage | Treatments |
| 1 | Black Velvet | Ozonated for 1, 2, and 5 min |
| | whiskey | |
| 2 | Black Velvet | Ozonated for 0, 20, and 40 min |
| | whiskey | |
| 3 | Black Velvet | Ozonation level: 0, 2.8, 5.6, 11.2, 22.24, 44.7, |
| | whiskey | 67.1, 89.5, 111.18 mg/L |
| 4 | Black Velvet | Ozonation level: 0, 3.1, 6.2, 12.4, 24.8, 49.6, |
| | whiskey | 74.4, 99.2, 124 mg/L |
| 5 | Black Velvet | 0, 5.6, 11.2 mg/L. All ozonation treatments with |
| | whiskey | and without filtration |
| 6 | Vodka | Ozonation level: 0, 2.88, 5.77, 11.54, 17.31, |
| | | 23.08, 28.85, 34.62, 51.93, 69.24 mg/L |
| 7 | Vodka | Ozonation level: 0, 5.6, 11.2 mg/L. All ozonation |
| | | treatments with and without filtration |
| 8 | Jack Daniels | Ozonation level: 0, 5.69, 11.38, 22.75, 34.13, |
| | whiskey | 56.88, 85.32 mg/L |

Typically, esters contribute desirable fruity aroma characteristics to foods, terpenoids contribute earthy aroma characteristics and aldehydes contribute green or oxidized aroma characteristics. Analysis of initial Black Velvet whiskey samples (Runs 1 and 2) showed significant decreases in esters and terpenoids contents and increases in aldehydes and other oxidation product contents.

The samples from Run 2 were analyzed at 0, 2, and 4 weeks after ozonation treatment. Results indicated that effects of ozonation on the volatile flavor profiles of the whiskey were not affected by room temperature storage.

Further experiments were conducted (Runs 3 and 4) to examine the effect of time and dose of ozonation treatment on volatile flavor compounds in Black Velvet whiskey. These studies showed that increases or decreases in the volatile flavor compounds were not consistent throughout a range of ozonation treatment. The ozonation treatment did contribute to a significant decrease in the color intensity of the whiskey.

The effect of ozonation treatment on the volatile flavor profile of Black Velvet and Jack Daniels whiskeys was evaluated in Runs 5 and 8. The two brands of whiskey differ greatly in their volatile flavor profiles, with the Jack Daniels whiskey having a more complex volatile profile with more volatile flavor compounds present at higher levels (40-50 compounds present in Black Velvet whiskey; 60-70 compounds present in Jack Daniels whiskey (Run 8)). The effects of the ozonation treatment were dependent on specific flavor compounds with decreases in esters and terpenoid compounds and increases in the aldehydes and other oxidation products. Granular activated carbon adsorption resulted in no change or decrease in the flavor compounds in the Black Velvet whiskey.

Vodka was also analyzed (Runs 6 and 7) to determine effect of ozonation treatment on its volatile flavor profile. In comparison to the whiskeys, the vodka contained only 15-20 volatile flavor compounds. Nontheless, taste testing of the vodka indicated an improvement.

### EXAMPLE 2

Most of the odors in liquors and in the beverage alcohols originate from the fermentation process. The fermentation process is done under anaerobic conditions so that there has not been an opportunity for the oxidation of the odor substances. For example, there are more than 30 identifiable aromas in a whiskey headspace (the volume left at the top of an almost filled container). The overwhelming majority of aromas provide a neutral to pleasant hedonic tone. However, a few very unpleasant odors characterized as ‘rotten eggs’, ‘fecal’, ‘body odor’, ‘skunky’, and ‘barnyard’ were found in some well-known whiskey brands. Controlling or removing these undesirable odors is important to maintain or improve the whiskey quality.

In this EXAMPLE, volatile organic compounds (VOCs) released from four different liquor samples were identified by headspace extraction with solid phase microextraction and analysis on a multidimensional gas chromatograph-mass spectrometry-olfactometry (HS-SPME-MDGC-O) system. TABLE II summarizes and compares VOCs released from four different liquor samples. The TABLE II also shows comparisons between treatment (T) with high ozone dosages and no treatment (C). The ozone treatment was between 20 and 50 mg/L and concluded with granular activated carbon adsorption.

TABLE II

| | Column | | | | Match | E&J | | Paramount | | Seagram | Black |
|---|---|---|---|---|---|---|---|---|---|---|---|
| | retention | | | Base | of MS | Brandy | | Rum | | Gin | Velvet |
| No | time (min) | Compound name | CAS | Ion | (%) | C | T | C | T | T | T |
| 1 | 1.45 | Acetaldehyde | 75-07-0 | 44 | 63 | y | y | y | y | y | y |
| 2 | 1.98 | Formic, ethyl ester | 109-94-4 | 45 | 86 | y | y | | Y | y | y |
| 3 | 2.62 | 2-Butanone, 3-hydroxy- | 513-86-0 | 45 | 59 | | | | | y | y |
| 4 | 2.63 | Acetic acid, ethyl ester | 141-78-6 | 43 | 74 | y | y | y | y | y | y |
| 5 | 2.66 | Ethanol | 64-17-5 | 31 | | y | y | y | y | y | y |
| 6 | 3.58 | Ethane, 1,1-diethoxy- | 105-57-7 | 45 | 70 | y | y | | | y | y |
| 7 | *4.31 | 2-Butanol | 78-92-2 | 45 | 33 | | | | | | y |
| 8 | 4.53 | 1-Propene, 2-fluoro- | 1184-60-7 | 59 | 50 | y | y | | | | |
| 9 | 4.55 | 3-Cyclohexene-1-carboxaldehyde | 100-50-5 | 79 | 65 | | | | Y | y | |
| 10 | 5.50 | 1-Heptene, 5-methyl- | 13151-04-7 | 70 | 63 | | | Y | | | |
| 11 | *5.53 | 1-Propanol, 2-methyl- | 78-83-1 | 43 | 81 | y | y | | | y | y |
| 12 | 5.98 | Butanoic acid, ethyl ester | 105-54-4 | 43 | 83 | y | y | y | y | y | y |
| 13 | *6.55 | Hexanal | 66-25-1 | 44 | 69 | | Y | | | | y |
| 14 | 8.01 | Isoamyl acetate | 123-92-2 | 43 | 59 | Y | y | y | | | |
| 15 | *8.08 | Isoamyl alcohol | 123-51-3 | 41 | 83 | Y | y | y | y | | y |
| 16 | 8.18 | alpha-Pinene | 80-56-8 | 93 | 95 | | Y | y | y | y | y |
| 17 | 9.01 | Xylene | 1330-20-7 | 91 | 93 | Y | | | | | |
| 18 | 10.18 | 1-Butanol, 3-methyl-, propanoate | 105-68-0 | 57 | 72 | | | Y | | | |
| 19 | 10.28 | Bornylene | 464-17-5 | 93 | 88 | | | Y | | | |
| 20 | 11.00 | Hexanoic acid, ethyl ester | 123-66-0 | 88 | 95 | Y | y | y | y | y | y |
| 21 | 11.21 | dl-Limonene | 138-86-3 | 68 | 96 | Y | | y | y | y | y |
| 22 | *11.33 | Hexanol | 111-27-3 | 56 | 63 | Y | y | | | | |
| 23 | 11.58 | 1-Hexyl acetate | 142-92-7 | 43 | 83 | Y | | | | | |
| 24 | 11.78 | Benzene, 1-methyl-4-[1- | 99-87-6 | 119 | 93 | Y | y | y | y | y | |
| | | methylethyl]- | | | | | | | | | |
| 25 | *12.91 | Acetic acid | 64-19-7 | 43 | 83 | Y | y | | Y | | y |
| 26 | 13.40 | 2-Furancarboxyaldehyde | 98-01-1 | 96 | 88 | Y | y | | Y | y | y |
| 27 | 14.78 | Benzaldehyde | 100-52-7 | 106 | 93 | Y | y | Y | | | |
| 28 | 15.53 | Octanoic acid, ethyl ester | 106-32-1 | 88 | 96 | Y | y | y | y | | y |
| 29 | 15.93 | Campor | 76-22-2 | 95 | 95 | | | | Y | y | |
| 30 | *15.95 | 3-sec-Butyl-2-mwthoxy pyrazine | 24168-70-5 | 138 | 61 | | Y | | | | y |
| 31 | 17.91 | Cyclohexene, 4-methyl-1-[1- | 500-00-5 | 95 | 86 | | | Y | | | |
| | | methylethyl]- | | | | | | | | | |
| 32 | 18.01 | Butanoic acid, diethyl ester | 123-25-1 | 101 | 69 | Y | | | | | |
| 33 | 18.03 | Acetic acid 1,7,7-trimethyl- | 92618-89-8 | 95 | 93 | | | | Y | y | |
| | | bicyclo[2,2,1]hept-2-yl ester | | | | | | | | | |
| 34 | 19.56 | Decanoic acid, ethyl ester | 110-38-3 | 88 | 96 | Y | y | Y | | | |
| 35 | 20.01 | Hexadecane, 2,6,10,14- | 638-36-8 | 57 | 74 | | | | | y | |
| | | tetramethyl- | | | | | | | | | |
| 36 | 20.31 | Propanoic acid, 2-phenylethyl ester | 122-70-3 | 104 | 63 | Y | | | | | |
| 37 | 20.85 | Tetradecane, 2-methyl- | 1560-95-8 | 57 | 76 | | | | | y | y |
| 38 | *21.15 | Benzeneethanol | 60-12-8 | 91 | 91 | Y | | | | | |
| 39 | 21.20 | Pentadecane, 2,6,10,14- | 1921-70-6 | 57 | 88 | | | | | y | |
| | | tetramethyl- | | | | | | | | | |
| 40 | 22.06 | delta-Cadinene | 483-76-1 | 161 | 94 | | | | | y | |
| 41 | *22.4 | Phenol | 108-95-2 | 94 | 91 | Y | y | Y | | | |
| 42 | 23.18 | Dodecanoic acid, ethyl ester | 106-33-2 | 88 | 91 | Y | | Y | | | |
| 43 | 23.65 | Decane, 2-methyl- | 6975-98-0 | 57 | 69 | | | | | y | y |
| 44 | 24.35 | Decane, 5-ethyl-5-methyl- | 17312-74-2 | 57 | 68 | | | | | y | y |
| 45 | 24.40 | Undecane, 4,6-dimethyl- | 17312-82-2 | 57 | 63 | | | | | y | |
| 46 | 24.70 | Hexadecane, 7,9-dimethyl- | 21164-95-4 | 57 | 82 | | | | | y | y |

*9 compounds were confirmed with pure standards
T = treated liquor
C = control (untreated liquor)
y = compounds found in sample
Y = compound present in either C or T in the same kind of liquor;
CAS is Chem Abstracts source and “Match of MS” is match with mass spectrometry values.

### EXAMPLE 3

This EXAMPLE evaluated whiskey volatiles. The evaluation was done in the Atmospheric Air Quality Laboratory (AAQL) in the National Swine Research and Information Center, Department of Agricultural and Biosystems Engineering, Iowa State University. The AAQL was equipped with a multidimensional gas chromatograph with mass spectrometry detector and olfactory detection port (MDGC-MS-O). An MDGC-MS-O is a “state-of-the-art” aroma/off odor analytical device. The MDGC-MS-O in this EXAMPLE was provided from Microanalytics, Round Rock, Tex., US. This device provides a simultaneous chemical and sensory analysis of volatile flavor compounds. The system integrates GC-O with GC-MS (Agilent 6890N GC/5973 MS from Agilent, Wilmington, Del., USA) as a base platform and includes an olfactory port and flame ionization detector (FID). In the EXAMPLE, the system was equipped with a non-polar precolumn and polar column in series as well as system automation and data acquisition software (MultiTrax™ V. 6.00 and AromaTrax™ V. 6.61, from Microanalytics and Chemstation™, from Agilent). The general run parameters used were as follows: injector, 260° C.; FID, 280° C., column, 40° C. initial, 3 min hold, 7° C./min, 220° C. final, 10 min hold; carrier gas, He. Mass/molecular weight to charge ratio (m/z) range was set between 33 and 280. Spectra were collected at 6/sec and electron multiplier voltage was set to 1000 V. The MS detector was auto-tuned weekly.

Compounds were identified by comparison against three criteria: (1) match of a retention time on the MDGC capillary column with retention time of pure compounds run as standards; (2) match of mass spectrums of unknown compounds with BenchTop/PBM MS library search system (from Palisade Mass Spectrometry, Ithaca, N.Y., USA) and spectrums of pure compounds; and (3) match of odor character. Qualitative assessment of VOC abundance was measured as area counts under peaks for separated VOCs. Human panelists were used to sniff separated compounds simultaneously with the conducting of chemical analyses. Odor of separated VOCs was evaluated against a 64-descriptor panel and intensity scale in Aromatrax software. Odor evaluations consisted of comparisons of the number of odor/aroma events, with odor intensity measured as the area under odor/aroma peaks in aromagrams.

A solid-phase microextraction (SPME) fiber 85 μm Carboxen/PDMS) and manual fiber holder (Supelco, Bellefonte, Pa., US) were used for sampling of volatile and semi-volatile flavor components. SPME extractions were performed with a manual fiber holder from Supelco (Bellefonte, Pa., USA) to extract volatile compounds from headspace above samples. Before use, each SPME fiber was conditioned in a heated injection port under He flow. Screw-capped vials from Supelco (40 mL) sealed with a polytetrafluoroethylene (PTFE)-lined silicone septum were used for headspace sampling. Then, the fiber septums were pierced and exposed to the sampled headspace for 1 hr. After exposure, the fiber was removed from the vial and immediately inserted into the injection port of the GC of the MDGC-MS-O system for analysis. Desorption time for each SPME fiber was 40 min at 260° C.

Ozonated samples and also EXAMPLE 1 samples that were subjected to both ozonation and GAC treatment were subjected to analysis of headspace above the samples by the gas chromatography/mass spectrometry equipment and also subjected to sensory evaluation.

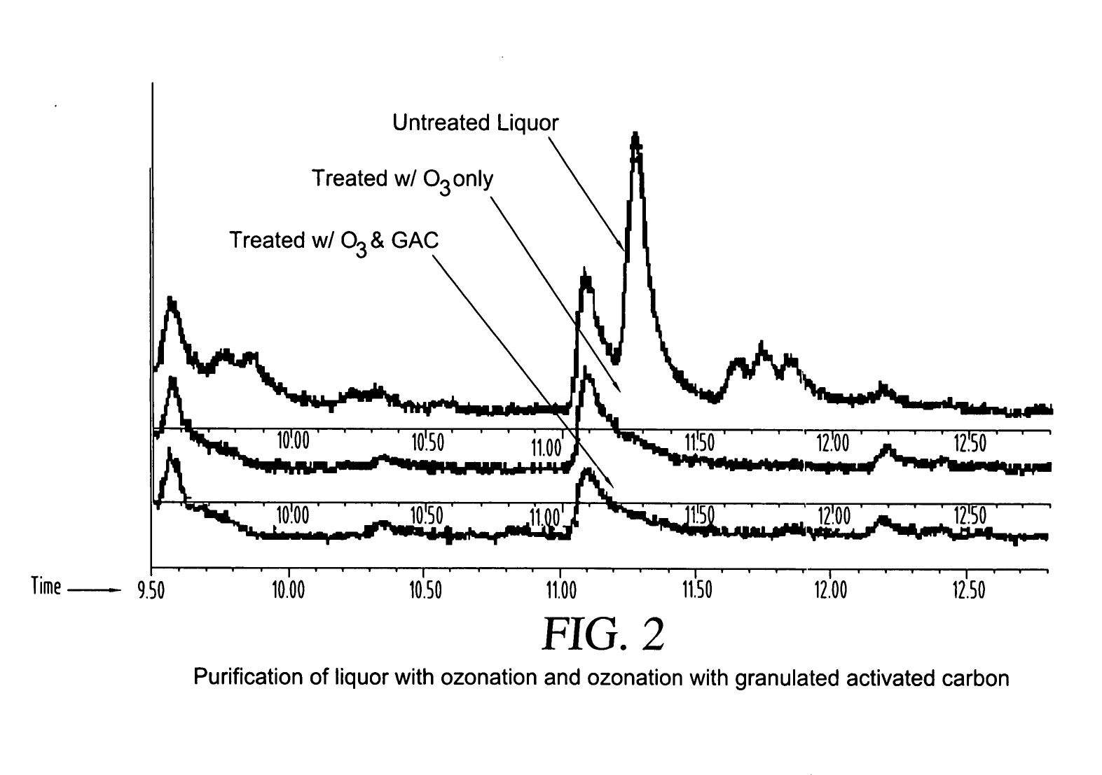

FIG. 2 shows MDGC-MS-O chromatography results from products of treatment of a whiskey by ozonation and by ozonation combined with a GAC filtration. The FIG. 2 shows comparison of chromatograms of Black Velvet® whiskey. In the treatment procedure, the Velvet® whiskey was dosed with 11 mg/L ozone. FIG. 2 is a total ion chromatogram representing MS detector response (vertical axis) to separated compounds eluting from a chromatographic column at specific retention times (horizontal axis). The FIG. 2 chromatogram peaks are identified as follows: (1)=3-methylnonane, (2)=4-methyldecane, (4)=limonene, (5)=1-dodecene, (6)=4-ethyl-xylene, (7)=p-cymene. The O₃+GAC treatment removed part of (3)=ethyl hexanoate.

Responses to samples treated with ozone only, treated with ozone and GAC adsorption and non-treated (control) were determined. Both odor intensity and odor duration were established by a panelist during each sample analysis using the MDGC-MS-Olfactometry system. Each unpleasant odor was quantified as a product of odor intensity and odor duration. Odor reduction was computed as the removal efficiency (%) based on the sum of total unpleasant odors. Results showed that offensive odors, caused by sulfurous compounds such as methyl mercaptan, dimethyl trisulfide, and phenolic compounds such as p-cresol, were removed by ozonation. Overall removal rates for very unpleasant odors characterized as ‘rotten eggs’, ‘fecal’, ‘body odor’, ‘skunky’, ‘piggy’, ‘urinous’ and ‘barnyard’ were 45.0% and 50.9% for ozone only and ozone plus GAC treatments, respectively.

### EXAMPLE 4

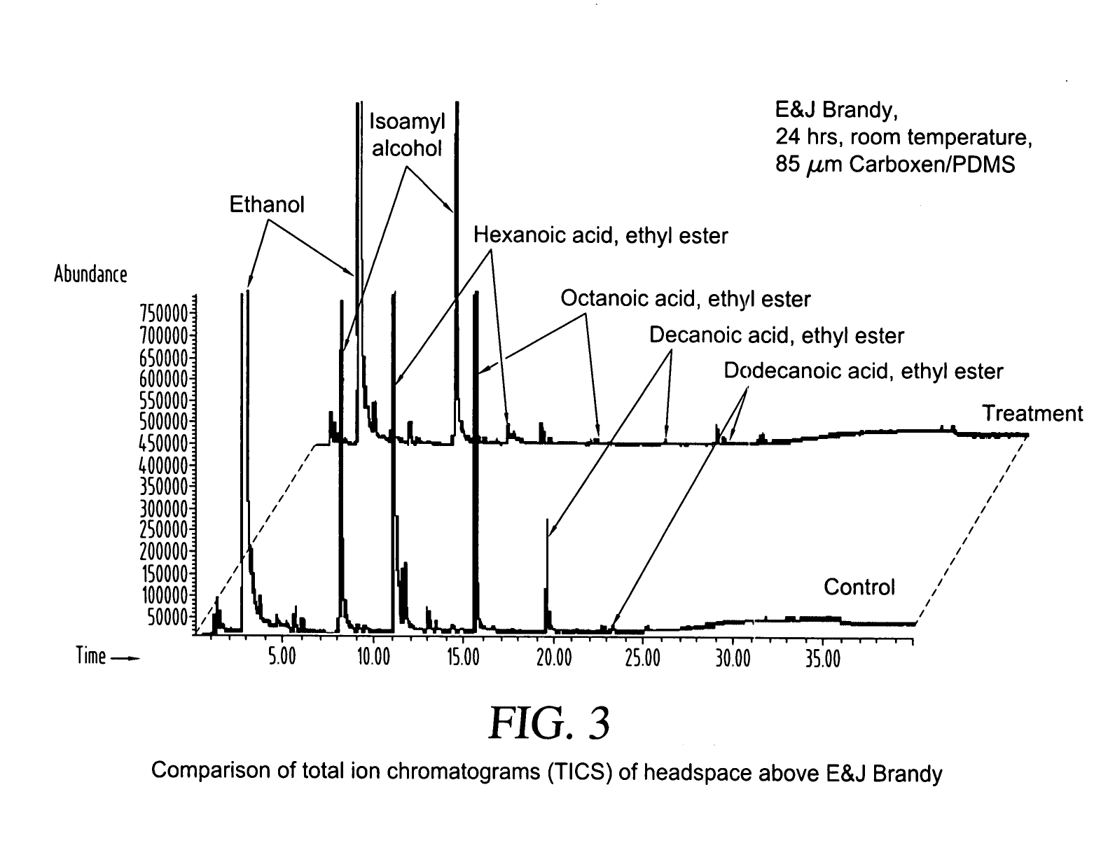

In this EXAMPLE, several liquors were ozonated and treated with GAC. FIG. 3 illustrates the effect of ozonation and GAC on brandy and rum. FIG. 3 is a comparison of total ion chromatograms (TICs) of headspace above E&J Brandy for treated and untreated samples. In the FIG., “control” signifies untreated liquor and “treatment” signifies liquor treated with ozone.

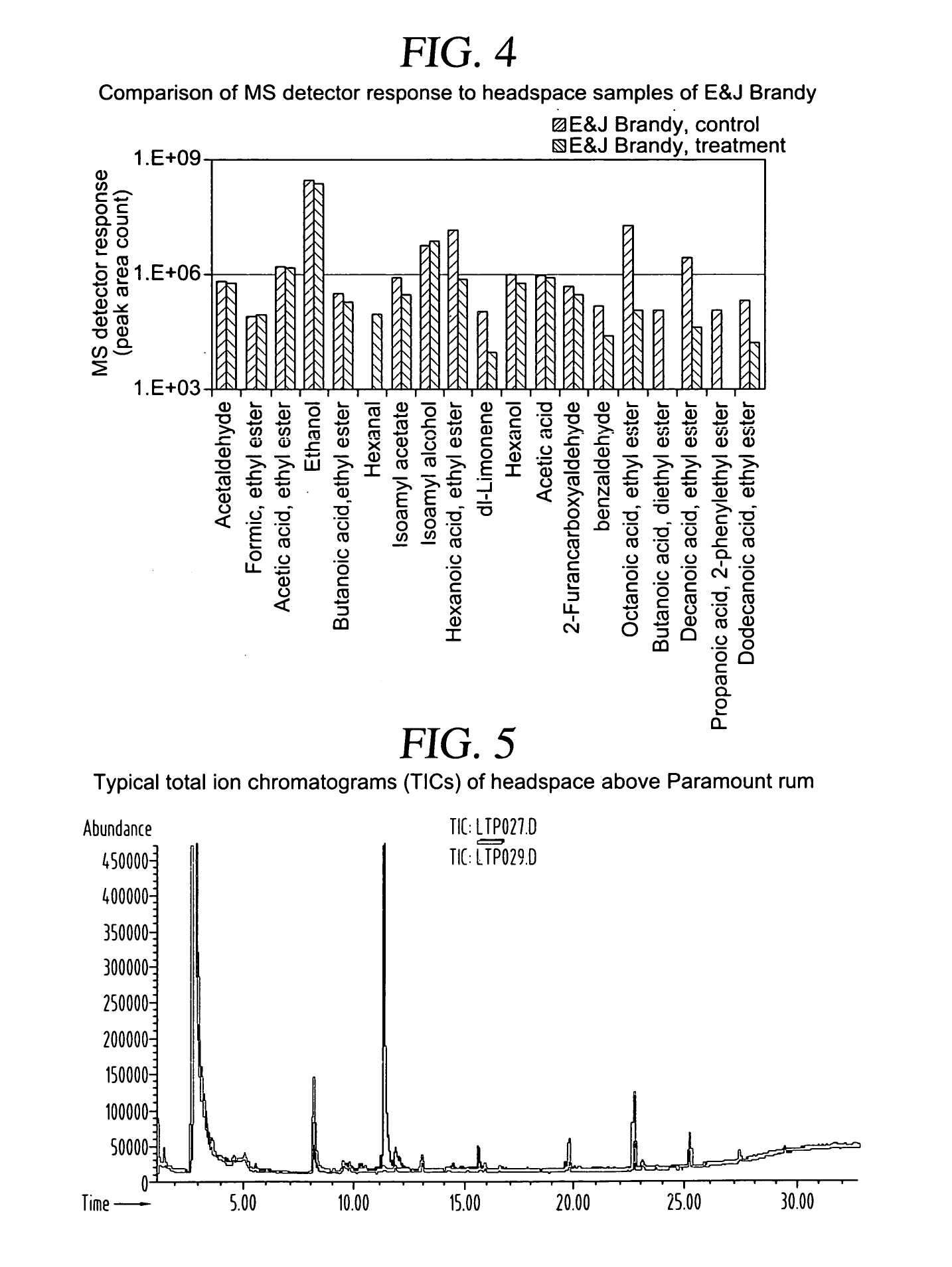

FIG. 4 is a comparison of MS detector response to headspace samples of E&J Brandy. FIG. 5 shows total ion chromatograms (TICs) of headspace above Paramount rum. FIG. 5 shows a difference in chromatograms for Paramount rum. Similarly to E&J brandy (FIGS. 3 and 4), ozonation tended to reduce the presence of many major esters. In the FIG., “control” signifies untreated liquor and “treatment” signifies liquor treated with ozone.

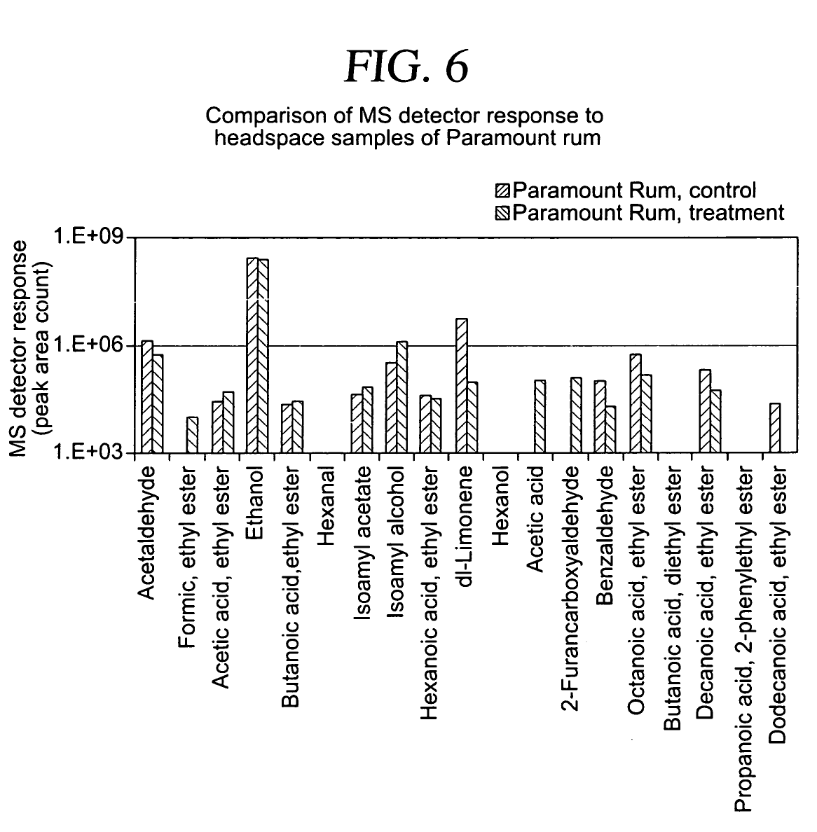

FIG. 6 is a comparison of MS detector response to headspace samples of Paramount rum. Also, FIG. 6 shows the volatiles measured in Paramount rum. Similarly to E&J Brandy (FIGS. 3 and 4), ozonation tended to reduce the presence of many major esters. However, acetic acid and furancarboxylaldehyde were generated by the treatment. In the FIG., “control” signifies untreated liquor and “treatment” signifies liquor treated with ozone.

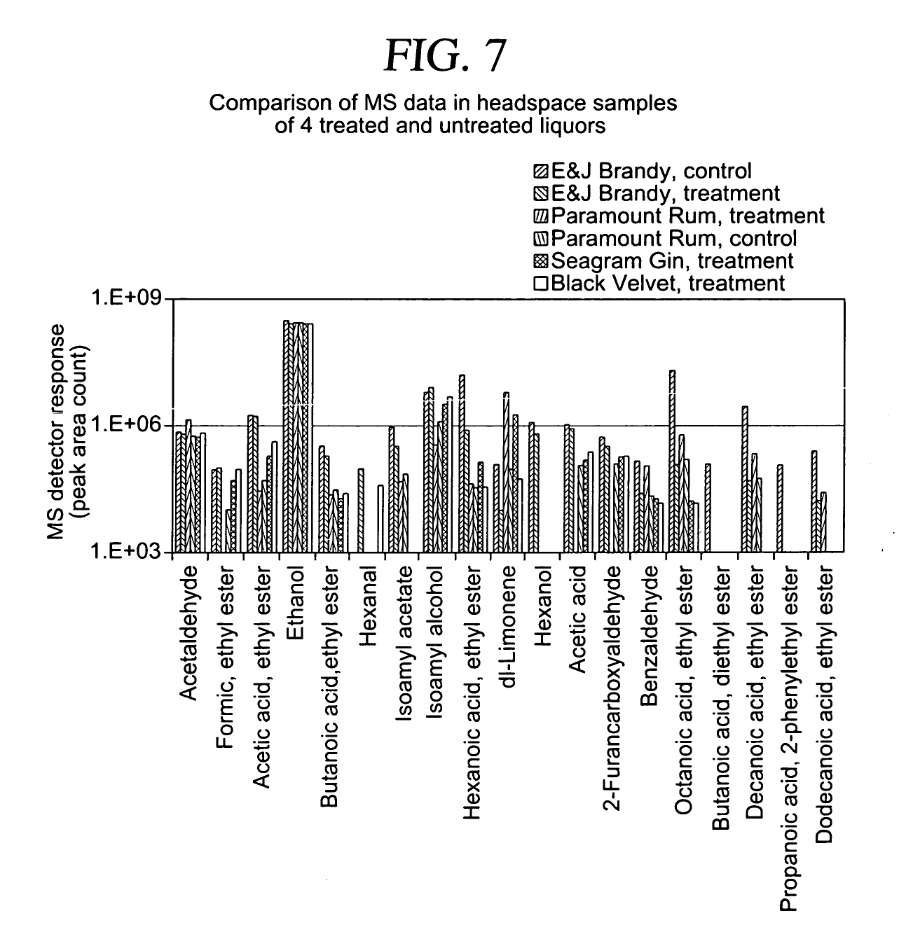

FIG. 7 is a comparison of MS data in headspace samples of four treated and untreated liquors. FIG. 7 summarizes all the results of mass spectrometry of the liquors tested.

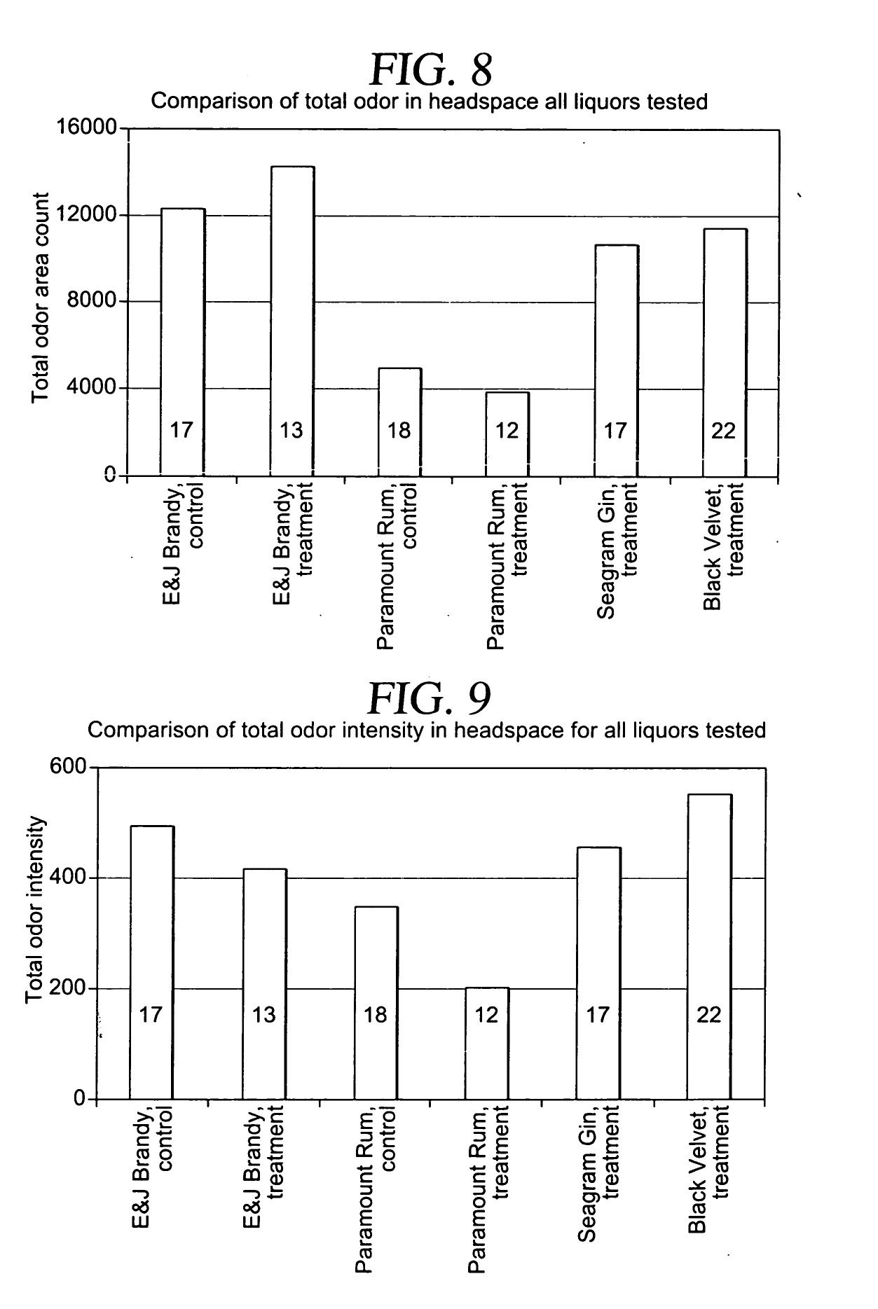

Total odor was measured as the sum of products of odor intensity and odor duration for all odor events in a sample. These results are shown in FIG. 8. FIG. 8 is a comparison of total odor in headspace of the tested liquors. Numbers on columns signify the total number of odors detected in the headspace. In the FIG., “control” signifies untreated liquor and “treatment” Treatment with ozone resulted in significant reduction of distinct odorants/aromas in headspace.

Total odor intensity was measured as the sum of odor intensities for all odor events in the sample. These results are shown in FIG. 9. FIG. 9 is a comparison of total odor intensity in headspace for tested liquors. Numbers on columns signify the total number of odors detected in headspace. “Control” signifies untreated liquor and “treatment” signifies liquor treated with ozone. Treatment with ozone resulted in significant reduction of distinct odorants/aromas in the headspace. The FIG. 9 shows a substantial improvement to cheaper whiskies and to beverage alcohol. The results establish a reduction in total odor/aroma intensities for a given type of sample as a result of treatment with ozonation and granular activated carbon.

### EXAMPLE 5

The above headspace analysis of volatiles in a product with MDGC-MS-olfactory characterization of individual aroma components confirmed removal of individual or group components such as limonene and its oxidation product p-cymene, and selected alkenes and aromatic substances. Additionally, sensory tests were conducted with a tasting panel of 25 volunteers. The results of the tasting demonstrated a preference for ozone treated whiskey samples over the same untreated whiskey sample.

In the tasting, tasters imbibed three Black Velvet Whiskey (80 proof blended whiskey, distilled and aged by Barton Brands, Canada, $10/L) samples, blindly identified as A, B and C. Samples A and B were treated by bubbling an Enaly generated ozonated air through 250 mL of the whiskey. Sample B was also treated by standing for five minutes in a beaker with 300 GAC, 12-40 mesh size Filtrasorb® product (Calgon Corporation, 400 Media Drive Pittsburgh Pa. 15205). Black Velvet Whiskey sample C was untreated.

The tasters were 25 degreed faculty members of Iowa State University. The tasters tasted the whiskey samples in an A, B then C order, each in a 10 ml quantity. The tasting was conducted over a period of 45 minutes. Cheese, nuts and water were provided between tastings. Each taster was provided with an identical form to indicate an A, B or C preference. Eight (8) tasters preferred sample A, 9 tasters preferred B, 5 preferred C and three indicated difficulty in making a choice.

The present process of treating a distilled alcohol to make a higher quality beverage alcohol can advantageously increase the value of sales in the state, generating more revenue, enhance export potential of beverage alcohol and create increased opportunities for local production of finished whiskeys. One analysis estimates a $1 to $3 price improvement per bottle or $5 to $15 per gallon to a whiskey treated by the process of the invention.

The above analytical and sensory tests demonstrate efficacy of ozone to selectively remove less desirable components in whiskey, and other commercial drinking alcohol, leading to an enhanced product at a cost of less than a penny per liter.

While preferred embodiments of the invention have been described, the present invention is capable of variation and modification and therefore should not be limited to the precise details of the EXAMPLES. The invention includes changes and alterations that fall within the purview of the following claims.

What is claimed is:

1. A method of treating a distilled spirit, comprising contacting the distilled spirit with ozone and recovering an ozonated distilled spirit product of improved aroma, taste or character.

2. The method of claim 1, further comprising subjecting the ozonated distilled spirit to adsorption to remove first congeners.

3. The method of claim 1, comprising subjecting the ozonated distilled spirit to absorption with granulated activated charcoal (GAC).

4. The method of claim 1, further comprising subjecting the ozonated distilled spirit to adsorption to remove first congeners and subjecting the product to filtration to produce a distilled spirit product of improved aroma, taste or character.

5. The method of claim 1, wherein the distilled spirit is a distillate from a grain fermentation process.

6. The method of claim 1, wherein the distilled spirit is an alcohol beverage.

7. The method of claim 1, wherein the distilled spirit is a whiskey.

8. The method of claim 1, further comprising subjecting the ozonated distilled spirit to adsorption wherein the distilled spirit includes sulfurous compounds and phenolic compounds that are substantially removed by the ozonation and adsorption to improve aroma, taste or character of the spirit.

9. The method of claim 1, further comprising subjecting the ozonated distilled spirit to adsorption wherein the distilled spirit includes a methyl mercaptan and a dimethyl trisulfide that are substantially removed by the ozonation and adsorption to improve aroma, taste or character of the spirit.

10. The method of claim 1, further comprising subjecting the ozonated distilled spirit to adsorption wherein the distilled spirit includes p-cresol, which is substantially removed by the ozonation and adsorption to improve aroma, taste or character of the spirit.

11. The method of claim 1, comprising distilling a whiskey spirit from a malt cooker, cooling the spirit to a whiskey, contacting the whiskey with ozone and recovering an ozonated whiskey product of improved aroma, taste or character.

12. The method of claim 1, comprising distilling a whiskey spirit from a malt cooker, cooling the spirit to a whiskey, contacting the whiskey with ozone and subjecting the ozonated whiskey product to adsorption to remove first congeners.

13. The method of claim 1, comprising distilling a whiskey spirit from a malt cooker, cooling the spirit to a whiskey, contacting the whiskey with ozone, subjecting the ozonated whiskey product to adsorption to remove first congeners and subjecting the ozonated whiskey product adsorption to produce a product of improved aroma, taste or character.

14. The method of claim 1, comprising contacting the distilled spirit with a dosage of ozone of less than 1000 mg/L.

15. The method of claim 1, comprising contacting the distilled spirit with a dosage of ozone between 5 mg/L to 30 mg/L.

16. A method of processing a whiskey, comprising continuously charging a condensed distilled fermentation product to the top of a processing column to flow downwardly through the column;
supplying ozone to the bottom of the processing column to flow countercurrently against and to intimately contact the downwardly flowing product to produce an ozonated product from the whiskey;
charging the ozonated product from the processing column to the top of an adsorption column; and
flowing the ozonated product downwardly through the adsorption column to recover an improved whiskey product at the bottom of the adsorption column.

17. The method of claim 16, wherein the filtration column comprises a column of GAC.

18. A system for processing a whiskey, comprising:
an ozone generator; and
a contact tower with a lower continuous ozone contacting gas feed from the ozone generator, an upper liquid whiskey feed and a recovery port to recover an ozonated whiskey product.

19. The system of claim 18, further comprising an adsorption vessel connected to receive the whiskey product from the contact tower recovery port and containing an adsorption medium.

20. The system of claim 18, further comprising a cooker to vaporize a spirit and a distillation tower to condense the spirit to the liquid whiskey feed.
